(19) United States
(12) Patent Application Publication
(10) Pub. No.: US 2025/0293228 A1
(43) Pub. Date: Sep. 18, 2025

(54) MANUFACTURING METHOD OF ELECTRODE PLATE

(71) Applicants: Prime Planet Energy & Solutions, Inc., Tokyo (JP); KOMATSU NTC LTD., Toyama-ken (JP)

(72) Inventors: Masanori SUZUKI, Takatsuki-shi (JP); Muneyasu TAKAGAKI, Osaka-shi (JP); Toshihiro NODA, Toyohashi-shi (JP); Yasuo HASEGAWA, Nanto-shi (JP); Toshinori YASOSHIMA, Nanto-shi (JP); Hideki SAITO, Nanto-shi (JP)

(21) Appl. No.: 19/075,785

(22) Filed: Mar. 11, 2025

(30) Foreign Application Priority Data
Mar. 18, 2024 (JP) 2024-042894

(51) Int. Cl. H01M 4/04; B23K 26/082; B23K 26/38; B23K 101/38

(52) U.S. Cl. CPC H01M 4/04; B23K 26/082; B23K 26/38; B23K 2101/38

(57) ABSTRACT

A herein disclosed manufacturing method of an electrode plate includes a preparing a strip-like shaped electrode plate base material, and manufacturing an electrode plate that comprises plural electrode tabs at an end part in a shorter direction, by carrying the electrode plate base material in a first direction being along a longitudinal direction of the electrode plate base material and irradiating a laser to the electrode plate base material in carry. Then, at the manufacturing an electrode plate, a scanning speed of the laser on the electrode plate base material is controlled to make a relative speed of an irradiation position of the laser with respect to the electrode plate base material in carry be constant.

### CROSS REFERENCE TO RELATED APPLICATIONS

The present application claims the priority based on Japanese Patent Application No. 2024-042894 filed on Mar. 18, 2024. The entire contents of the prior application are incorporated in the present specification by reference.

### BACKGROUND

### 1. Technical Field

A technique disclosed herein relates to a manufacturing method of an electrode plate.

### 2. Description of the Related Art

An electric storage device, such as lithium ion secondary battery, includes an electrode assembly in which a positive electrode plate and a negative electrode plate are opposed via a separator, for example. Below, these positive electrode plate and negative electrode plate are referred to as “electrode plate”, all together. This electrode plate includes, for example, an electrode core body and an electrode active material layer. The electrode core body is a metal member formed in a foil shape. In addition, the electrode active material layer is imparted on a surface of the electrode core body, and includes an electrode active material. In a manufacture of the electrode plate having the above described configuration, at first, the electrode active material layer is imparted on the surface of the large electrode core body. By doing this, an electrode plate base material formed in a strip-like shape is manufactured. At an end part of this electrode plate base material in a shorter direction, a core body exposed area is formed on which the electrode active material layer is not imparted and on which the electrode core body is exposed. By cutting an area including this core body exposed area so as to have a concave and convex part in a plane view, an electrode tab is formed. For this cutting operation, it is possible to use a laser, or the like. An example of a technique related to formation of this electrode tab is disclosed by Japanese application publication 2022-82036, Japanese application publication 2021-146358, or the like.

### SUMMARY

Anyway, in a conventional technique, there is a possibility that a cut quality at an edge part of the electrode plate after the manufacture (in other words, a state of a cutting mark of the laser cut) happens to be varied. If the variation of the cut quality at the edge part of this electrode plate is caused, there is a fear that an excised portion being still attached to one part of the edge part of the electrode plate is forcibly torn off. By doing this, there is a fear that the electrode plate after the manufacture is broken. In addition, there is a fear that a foreign substance remained to be uncut is adhered to the edge part of the electrode plate after the manufacture, too. If this foreign substance is peeled off after a construction of the electric storage device, it becomes a cause of an inside short circuit. The herein disclosed technique is made to solve the above-described circumstances.

For the above described circumstances, a manufacturing method of an electrode plate having a below described configuration (below, simply referred to as “manufacturing method”, too) is provided.

The herein disclosed manufacturing method of the electrode plate includes a preparing a strip-like shaped electrode plate base material before a tab cut, and manufacturing the electrode plate that comprises plural electrode tabs at an end part in a shorter direction, by carrying the electrode plate base material in a first direction being along a longitudinal direction of the electrode plate base material and irradiating a laser to the electrode plate base material in carry. Then, at the manufacturing the electrode plate, a scanning speed of the laser on the electrode plate base material is controlled to make a relative speed of an irradiation position of the laser with respect to the electrode plate base material in carry be constant.

The present inventors have discussed about the cause of the cut quality variation at the edge part of the electrode plate after the manufacture, and as the result, have obtained a knowledge described below. At first, in the manufacture of the electrode plate, while the electrode plate base material is carried along the longitudinal direction, an irradiation position of the laser in the shorter direction of the electrode plate base material is moved. By doing this, at the end part in the shorter direction of the electrode plate after the manufacture, an electrode tab having a concave and convex shape can be formed. At that time, the electrode plate base material has been carried in the longitudinal direction. Accordingly, if the irradiation position of the laser is moved in the shorter direction at a low speed, movements in the longitudinal direction and a width direction are synthesized, and thus the electrode plate base material is cut largely in a diagonal direction. On the other hand, in the manufacture of the electrode plate, it is required to form the electrode tab having a shape along a standard of a battery (a concave and convex shape). Therefore, at a general tab cutting, a scanning speed of the laser in the shorter direction is set to be a high speed. However, if the laser is moved at the high speed as described above, a large difference is caused in relative speeds of the laser with respect to carry speeds of the electrode plate base material between a case of being cut along the shorter direction and a case of being cut along the longitudinal direction. As this result, on a laser track, an area heated for a long period by the laser whose relative speed is slow and an area heated for a short period by the laser whose relative speed is fast are caused. By doing this, there is a fear that the cut quality variation is caused at the edge part of the electrode plate after the manufacture. On the other hand, the manufacturing method disclosed herein controls the scanning speed of the laser on the electrode plate base material to make the relative speed of the irradiation position of the laser with respect to the electrode plate base material in carry be constant. By doing this, it is possible to suppress the cut quality variation at the edge part of the electrode plate after the manufacture.

### BRIEF DESCRIPTION OF THE DRAWINGS

FIG. 1 is a plane view that schematically shows an example of an electrode plate after manufacture.

FIG. 2 is a flowchart that shows a manufacturing method of the electrode plate in accordance with one embodiment.

FIG. 3 is a plane view that is for explaining the manufacturing method of the electrode plate in accordance with one embodiment.

FIG. 4 is a plane view that schematically shows a track of a laser on an area A in FIG. 3.

FIG. 5 is a plane view that schematically shows another example of the electrode plate after the manufacture.

### DETAILED DESCRIPTION

Below, while referring to figures, an embodiment of a herein disclosed technique would be explained. Incidentally, the matters other than matters particularly mentioned in this specification and required for practicing the present disclosure (for example, a general configuration and general manufacture process of an electric storage device) can be grasped as design matters of those skilled in the art based on the related art in the present field. The herein disclosed technique can be executed based on the contents disclosed in the present specification, and on the technical commonsense in the present field. Incidentally, a wording “A to B” representing a range in the present description is to semantically cover a meaning of being equal to or more than A and not more than B, and further cover meanings of being “preferably more than A” and “preferably less than B”.

Incidentally, a wording “electric storage device” in the present specification is a concept that semantically covers an apparatus generating a charge and discharge response in response to movement of charge carriers between a pair of electrode plates (a positive electrode plate and a negative electrode plate). In other words, the electric storage device on the herein disclosed technique semantically covers not only a secondary battery, such as lithium ion secondary battery, nickel hydrogen battery, and nickel cadmium battery, but also a capacitor, such as lithium ion capacitor, and electric double layer capacitor, or the like.

### 1. Explanation of Manufacturing Object

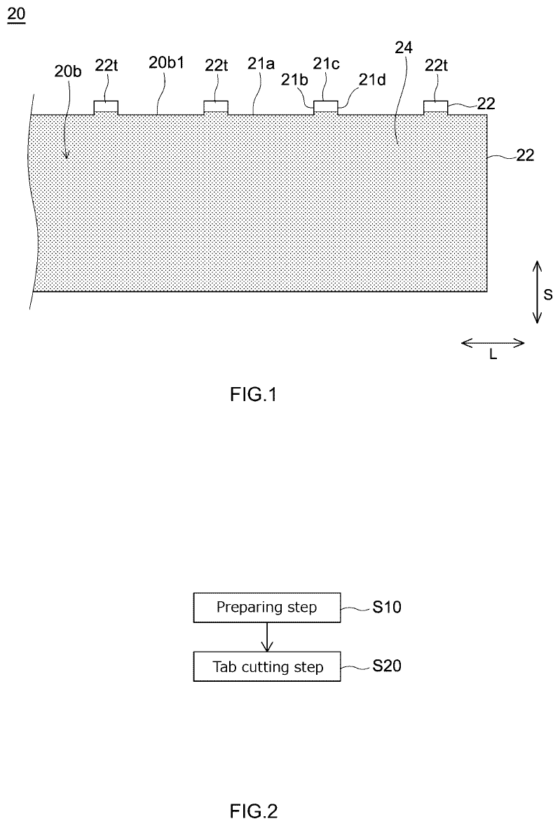

Below, an outline of the electrode plate being a manufacturing object will be described, and then a manufacturing method of the electrode plate in accordance with the present embodiment will be described. FIG. 1 is a plane view that schematically shows an example of the electrode plate after the manufacture. Regarding the manufacturing method in accordance with the present embodiment, a negative electrode plate 20 of the electric storage device is set to be the manufacturing object.

As shown in FIG. 1, the negative electrode plate 20 is a member formed in a long strip-like shape. The negative electrode plate 20 includes a negative electrode substrate 22 being a metal member formed in a foil shape, and includes a negative electrode active material layer 24 imparted on a surface of the negative electrode substrate 22. Incidentally, from a perspective of a battery performance, it is preferable that the negative electrode active material layer 24 is imparted on both surfaces of the negative electrode substrate 22. Then, this negative electrode plate 20 in a plane view includes an electrode plate body 20b and a negative electrode tab 22t. The electrode plate body 20b is an area where the negative electrode active material layer 24 is imparted on the surface of the negative electrode substrate 22. On the other hand, the negative electrode tab 22t is an area where the negative electrode active material layer 24 is not imparted and where the negative electrode substrate 22 is exposed. The negative electrode tab 22t is configured to protrude from one part of an edge part 20b1 in a shorter direction S of the electrode plate body 20b toward an outer side (upward in FIG. 1) in the shorter direction S. In addition, the negative electrode plate 20 includes plural negative electrode tabs 22t. These plural negative electrode tabs 22t are provided in a longitudinal direction L of the negative electrode plate 20 at predetermined intervals.

As described above, at one of the end parts in the shorter direction S of the negative electrode plate 20, the plural negative electrode tabs 22t are provided. On the end part positioned at a side where the negative electrode tabs 22t are provided (upward in FIG. 1), a first edge part 21a, a second edge part 21b, a third edge part 21c, and a fourth edge part 21d are formed. The first edge part 21a is configured to extend in the longitudinal direction L of the negative electrode plate 20. The second edge part 21b is configured to extend from the first edge part 21a to the outer side (upward in FIG. 1) in the shorter direction S. In addition, the third edge part 21c is configured to extend from a tip end of the second edge part 21b in the longitudinal direction L. Then, the fourth edge part 21d is configured to extend from a tip end of the third edge part 21c to an inner side (downward in FIG. 1) in the shorter direction S. As shown in FIG. 1, the first edge part 21a in the present embodiment is the same as the edge part 20b1 of the electrode plate body 20b. In addition, the negative electrode tab 22t in the present embodiment is an area surrounded by the second edge part 21b, the third edge part 21c, and the fourth edge part 21d. Although more details are described later, according to the herein disclosed technique, it is possible to suppress cut quality variations from being caused at each of these first edge part 21a to fourth edge part 21d.

For each of members configuring the negative electrode plate 20, it is possible to use a material used for a conventional and general electric storage device, without particular restriction. For example, as for the negative electrode substrate 22, it is preferably use a metal material having a predetermined electrically conductive property. It is preferable that the negative electrode substrate 22 described above is, for example, made from copper or copper alloy. In addition, a thickness of the negative electrode substrate 22 is preferably 2 μm to 30 μm, further preferably 3 μm to 20 μm, or furthermore preferably 5 μm to 15 μm.

The negative electrode active material layer 24 is a layer containing a negative electrode active material. For the negative electrode active material, in consideration of a relation with a positive electrode active material, a material is used which can reversibly store and release the charge carrier. As the negative electrode active material, it is possible to use a carbon material, a silicon type material, or the like. As the carbon material, it is possible to use, for example, a graphite, a hard carbon, a soft carbon, an amorphous carbon, or the like. In addition, it is also possible to use an amorphous carbon covered graphite where a surface of the graphite is covered by the amorphous carbon. On the other hand, as the silicon type material, it is possible to use a silicon, a silicon oxide (silica), or the like. In addition, the silicon type material might contain another metal element (for example, an alkaline earth metal), or an oxide of it. In addition, the negative electrode active material layer 24 might contain an additive agent, other than the negative electrode active material. As one example of the additive agent, it is possible to use a binder, a thickening agent, or the like. As a specific example of the binder, it is possible to use a rubber type binder, such as styrene butadiene rubber (SBR). In addition, as a specific example of the thickening agent, it is possible to use carboxymethyl cellulose (CMC), or the like. Incidentally, a content amount of the negative electrode active material, when a whole solid content of the negative electrode active material layer 24 is treated as 100 mass %, is approximately equal to or more than 30 mass %, or typically equal to or more than 50 mass %. Incidentally, the negative electrode active material might occupy 80 mass % or more of the negative electrode active material layer 24, or might occupy 90 mass % or more. In addition, a thickness of the negative electrode active material layer 24 is preferably 10 μm to 500 μm, further preferably 30 μm to 400 μm, or furthermore preferably 50 μm to 300 μm.

### 2. Manufacturing Method of Electrode Plate

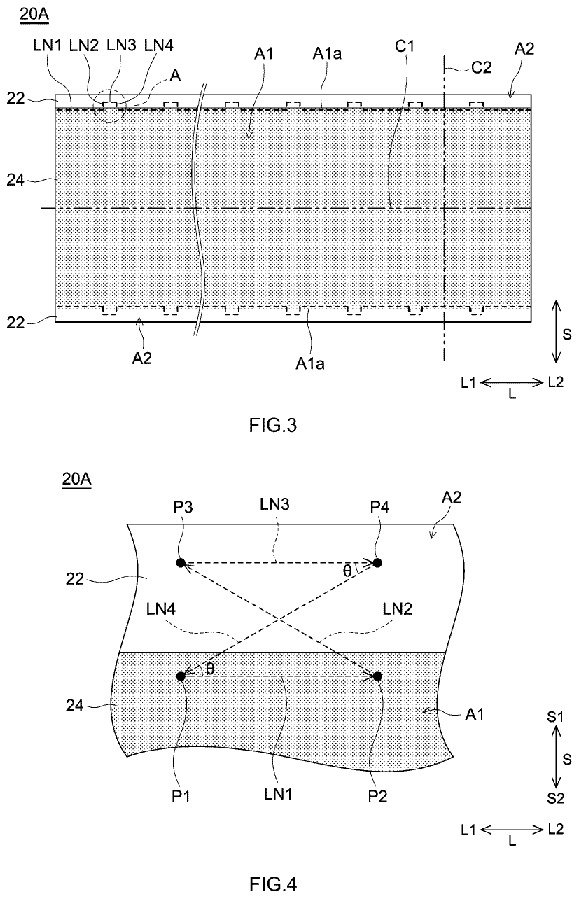

Next, a method for manufacturing the negative electrode plate 20 having the above described configuration would be described. FIG. 2 is a flowchart that shows the manufacturing method of the electrode plate in accordance with the present embodiment. In addition, FIG. 3 is a plane view that is for explaining the manufacturing method of the electrode plate in accordance with the present embodiment. As shown in FIG. 2, the manufacturing method in accordance with the present embodiment includes a preparing step S10 and a tab cutting step S20. Below, each of the steps would be described.

### (1) Preparing Step S10

At this step, an electrode plate base material formed in a strip-like shape before a tab cutting operation is prepared. The wording “electrode plate base material” in the present specification means an electrode plate before an electrode tab is formed. As shown in FIG. 3, in a case where the negative electrode plate 20 is manufactured, the electrode plate base material for the negative electrode plate 20 (hereinafter, which is referred to as “negative electrode plate base material 20A”) is prepared. This negative electrode plate base material 20A includes the negative electrode substrate 22 which is a metal foil formed in a strip-like shape. An area size of the negative electrode substrate 22 of this negative electrode plate base material 20A is larger than an area size of the negative electrode plate 20 after the manufacture (see FIG. 2). Then, on a surface of this negative electrode substrate 22, a negative electrode active material layer 24 is imparted. Incidentally, the negative electrode active material layer 24 is imparted at a central part of the negative electrode substrate 22 in the shorter direction S. Then, the negative electrode active material layer 24 is configured to extend along the longitudinal direction L. In the present specification, the area on which this negative electrode active material layer 24 is imparted is referred to as “negative electrode active material imparted area A1”. On the other hand, at both end parts of the negative electrode plate base material 20A in the shorter direction S (areas at outer sides in the shorter direction S more than the negative electrode active material layer 24), the negative electrode active material layer 24 is not imparted and thus the negative electrode substrate 22 is exposed. In the present specification, the area on which the negative electrode substrate 22 is exposed is referred to as “negative electrode substrate exposed area A2”. A means for preparing the negative electrode plate base material 20A having the above described configuration is not particularly restricted, and thus it is possible to use conventionally known various methods without particular restriction. For example, by applying a raw material paste containing the negative electrode active material, or the like, to coat the surface of the negative electrode substrate 22 and then by drying it, it is possible to manufacture the negative electrode plate base material 20A. In addition, the preparing step S10 is not particularly restricted, if it can prepare the negative electrode plate base material 20A. For example, the negative electrode plate base material 20A manufactured separately might be purchased for the preparation. Incidentally, the negative electrode plate base material is not restricted to a structure shown by FIG. 3. For example, as for the negative electrode plate base material, it is possible to select a structure where the negative electrode substrate exposed area is formed at only one of end parts in the shorter direction.

### (2) Tab Cutting Step S20

At the present step, while the electrode plate base material (the negative electrode plate base material 20A) is carried in a first direction L1 being along the longitudinal direction L, a laser is irradiated on the electrode plate base material in carry (the negative electrode plate base material 20A). Here, at the tab cutting step S20 in the present embodiment, while the negative electrode plate base material 20A is carried, an irradiation position of the laser is moved as shown by LN1 to LN4 in FIG. 4. As this result, on the negative electrode plate base material 20A, a laser track as shown by LN1 to LN4 in FIG. 3 is formed. In particular, FIG. 4 is a plane view that schematically shows the track of the laser on the area A in FIG. 3. FIG. 4 shows a movement pattern of the laser with respect to absolute positions at the tab cutting step S20. In a form shown by FIG. 4, the movement pattern of the laser with respect to the absolute positions is to move in a figure eight as shown by dotted lines LN1 to LN4. Although more details are described later, the absolute position of the laser in the present embodiment might be preceded in a direction (a second direction L2) opposite to a carry direction (the first direction L1). In addition, the absolute position of the laser might be, while proceeded in the carry direction (the first direction L1), proceeded to an outer side (a S1 direction) in the shorter direction. Furthermore, the absolute position of the laser might be, while proceeded in the carry direction (the first direction L1), proceeded to an inner side (a S2 direction) in the shorter direction. As a result that these laser tracks and the carry of the negative electrode plate base material 20A directed toward the first direction L1 are synthesized, then the negative electrode plate base material 20A is cut as shown by LN1 to LN4 in FIG. 3. Incidentally, the movement pattern of the absolute position of the laser shown by FIG. 4 can be previously programmed.

Here, the tab cutting step S20 in the present embodiment includes a first step, a second step, a third step, and a fourth step. Below, each of the steps would be described in detail.

### (a) First Step

As shown by the dotted line LN1 in FIG. 4, at the first step, while the irradiation position P1 of the laser in the shorter direction S is fixed, and the laser is relatively moved toward the second direction L2 that is a direction opposite to the first direction L1. In a case where this laser movement and a carry of the negative electrode plate base material 20A coming toward the first direction L1 are synthesized, as shown by the dotted line LN1 in FIG. 3, the negative electrode plate base material 20A is subjected to a laser cut along the longitudinal direction L. As this result, the first edge part 21a of the negative electrode plate 20 (see FIG. 1) is formed.

Incidentally, it is good for the irradiation position P1 of the laser at the first step to be moved relatively in the second direction L2 with respect to the negative electrode plate base material 20A in carry toward the first direction L1. In other words, an actual movement direction of the laser in the longitudinal direction Lis not particularly restricted. For example, when the laser is moved toward the second direction L2, as the result that it is synthesized with the carry of the negative electrode plate base material 20A toward the first direction L1, a relative speed (a processing speed) at which the laser cutting is performed becomes drastically fast. On the other hand, in a case where the irradiation position of the laser in the longitudinal direction L is fixed, the processing speed and the carry speed become the same speed. Additionally, in a case where the movement speed of the laser is made to be slower than the carry speed of the negative electrode plate base material 20A, the laser might be made to follow in the carry direction (the first direction L1). In any case, it is possible to perform the laser cutting on the negative electrode plate base material 20A along the longitudinal direction L. However, from a perspective of uniforming the relative speeds of the first step to the fourth step, it is preferable that the laser at the first step is made to move in the second direction L2 being opposite to the carry direction.

### (b) Second Step

As shown by the dotted line LN2 in FIG. 4, at the second step, after the above described first step, while an irradiation position P2 of the laser is moved in the first direction L1, it is moved to an outer side S1 in the shorter direction S. By doing this, as shown by the dotted line LN2 in FIG. 3, the negative electrode plate base material 20A is subjected to laser cutting along the outer side S1 in the shorter direction S. Particularly, if the irradiation position P of the laser is moved only in the shorter direction S in a state where the negative electrode plate base material 20A is carried in the longitudinal direction L, the longitudinal direction L and the shorter direction S are synthesized, and thus the negative electrode plate base material 20A happens to be cut in a diagonal direction. On the other hand, at the second step in the present embodiment, while the laser is made to follow in the first direction L1 (the carry direction), it is made to move to the outer side S1 in the shorter direction S. By doing this, relative movements in the longitudinal direction L are offset, and thus it is possible not only to suppress the scanning speed of the laser from being unnecessarily faster, but also to cut the negative electrode plate base material 20A toward the outer side S1 in the shorter direction S. As this result, it is possible to form the second edge part 21b configured to extend to the outer side S1 in the shorter direction S.

### (c) Third Step

As shown by the dotted line LN3 in FIG. 4, at the third step, after the above described second step, an irradiation position P3 of the laser in the shorter direction S is fixed, and then the irradiation position P3 of the laser is made to relatively move in the second direction L2. If this movement of the laser and the carry of the negative electrode plate base material 20A toward the first direction L1 are synthesized, as shown by the dotted line LN3 in FIG. 3, the negative electrode substrate exposed area A2 of the negative electrode plate base material 20A is subjected to the laser cutting along the longitudinal direction L. As this result, the third edge part 21c of the negative electrode plate 20 (see FIG. 1) is formed. Incidentally, similarly to the first step, the actual movement direction of the laser in the longitudinal direction L at the third step is not particularly restricted.

### (d) Fourth Step

As shown by the dotted line LN4 in FIG. 4, at the fourth step, after the above described third step, while an irradiation position P4 of the laser is made to move in the first direction L1, it is made to move to an inner side S2 in the shorter direction S. In other words, at the fourth step, while the laser is made to follow in the first direction L1 (the carry direction), it is made to move to the inner side S2 in the shorter direction S. By doing this, the relative movements in the longitudinal direction L are offset, and thus it is possible not only to suppress the scanning speed of the laser from being unnecessarily faster, but also to perform laser cutting on the negative electrode plate base material 20A along the inner side S2 in the shorter direction S. As this result, it is possible to form the fourth edge part 21d configured to extend to the inner side S2 in the shorter direction S.

Then, regarding the manufacturing method in accordance with the present embodiment, the above described first step is performed again after the laser reaches the irradiation position P4 of FIG. 4. In other words, at the tab cutting step S20 in the present embodiment, the first step to the fourth step (the laser movement along the dotted lines LN1 to LN4 in FIG. 4) are repeated. By doing this, it is possible to form the plural negative electrode tabs 22t at the end part in the shorter direction S of the negative electrode plate base material 20A.

Here, at the tab cutting step S20 in the present embodiment, the scanning speed of the laser on the negative electrode plate base material 20A is controlled to make the relative speed of the irradiation position of the laser with respect to the negative electrode plate base material 20A in carry be constant. By doing this, it is possible to suppress the cut quality variation at the edge part of the electrode plate after the manufacture. In particular, at a general tab cutting step, in order to form an electrode tab having a desired concave and convex shape in a plane view, it is required to move the laser at high speed along the shorter direction. However, if the scanning speed of the laser along the shorter direction is made to be faster, a difference in laser relative speeds with respect to the carry speed of the electrode plate base material is caused between the cut in the longitudinal direction and the cut in the shorter direction for which the high speed movement of this laser is not performed. As this result, there is a possibility that the cut quality variation is caused at the edge part of the electrode plate after the manufacture. On the other hand, the tab cutting step S20 in the present embodiment includes, as described above, the step (the second step, the fourth step, or the like) for making the laser follow in the carry direction (the first direction L1) of the negative electrode plate base material 20A. By making the laser follow in the carry direction as described above, it is possible to form the electrode tab having the desired concave and convex shape even if the scanning speed of the laser along the shorter direction is decreased. By doing this, it is possible to make the relative speed on the whole of the tab cutting step be constant, and thus it is possible to suppress the variation in the cut quality after the laser cutting.

Incidentally, the wording “the relative speed is constant” in the present specification means that, in a case where a mean value of the relative speeds on the whole tab cutting step S20 is treated as 100%, the relative speed at an arbitrary irradiation position becomes within a range of 90% to 110%. In an experiment of the present inventors, it has been confirmed that, when a fluctuation of the relative speeds is within a range of ±10%, the variation in the cut quality after the laser cut can be sufficiently suppressed. Incidentally, from a perspective of further surely inhibiting the cut quality variation, the above described fluctuation range of the relative speeds is preferably 92% to 108%, further preferably 94% to 106%, furthermore preferably 96% to 104%, or preferably in particular 98% to 102%. Incidentally, the mean value of the relative speeds in the present specification represents a mean value of the relative speeds of the laser at each of the first step to the fourth step.

Incidentally, as described above, the tab cutting step S20 in the present embodiment is configured with 4 steps of the first step to the fourth step. In this case, it is preferable that a scanning speed A of the laser at the first step, a scanning speed B of the laser at the second step, a scanning speed C of the laser at the third step, and a scanning speed D of the laser at the fourth step are set to satisfy Formula (1) and Formula (2) described below. By doing this, it is possible to make the relative speed at each of the first step to the fourth step be constant.

A=C<B (1)

A=C<D (2)

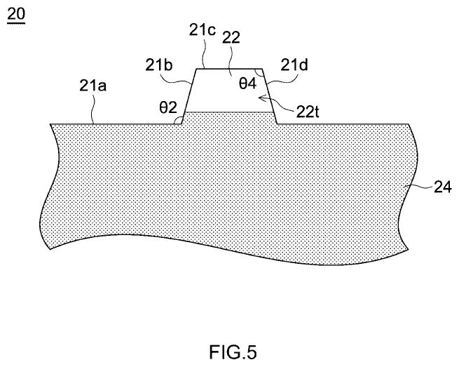

In addition, it is preferable that the scanning speeds A to D of the laser at respective steps are set on the basis of a carry speed V_{W} of the electrode plate base material, a ratio α of a total scanning distance of the laser with respect to a total length of the negative electrode plate base material 20A, an inclination angle θ2 of the second edge part 21b with respect to the longitudinal direction (see FIG. 5), and an inclination angle θ4 of the fourth edge part 21b with respect to the longitudinal direction (see FIG. 5). In particular, it is preferable that the scanning speeds A to D of the laser are controlled to satisfy Formula (3) to Formula (5) described below. As shown in FIG. 5, at the second step and the fourth step, it is required to relatively move the laser so as to make it be obliquely with respect to the first step and the third step. Therefore, by making the scanning speed B of the second step and the scanning speed D of the fourth step be faster on the basis of a trigonometric function as a below described formula, it is possible to easily make the relative speeds of the laser at the first step to the fourth step be constant.

A=C=V_{W}×α−V_{W} (3)

B=√(V_{W}²+V_{W}²×α−2V_{W}²×α×cos θ2) (4)

D=√(V_{W}²+V_{W}²×α−2V_{W}²×α×cos θ4) (5)

In addition, when the carry speed of the negative electrode plate base material 20A is set to be 100%, it is preferable that the mean value of the relative speeds of the laser be 120% to 130% (further suitably 125% to 129%, for example, 127.5%). As shown in FIG. 3, the track of the laser includes a concave and convex part, and thus becomes longer than a transportation path of the negative electrode plate base material 20A. With respect to this, as described above, if the relative speed of the laser is made to be faster than the carry speed of the negative electrode plate base material 20A, it is possible to easily make the total length of the negative electrode plate base material 20A and the total scanning distance of the laser become consistent with each other. As this result, it is possible to stably manufacture the negative electrode plate 20 including the plural negative electrode tabs 22t.

Incidentally, the particular carry speed of the negative electrode plate base material 20A is preferably equal to or more than 30 m/min, further preferably equal to or more than 35 m/min, furthermore preferably equal to or more than 40 m/min, or preferably in particular equal to or more than 45 m/min. By doing this, it is possible to enhance a production efficiency for the negative electrode plate 20. On the other hand, if the carry speed is increased, it becomes easy to cause a breakage on the negative electrode tab due to peeling of a curved surface part. However, the herein disclosed technique can suppress the curved surface part from being formed on the negative electrode tab 22t, and thus it is possible to implement the stable high speed carry. On the other hand, if the carry speed of the negative electrode plate base material 20A becomes too fast, it becomes difficult to implement the movement of the laser in accordance with the carry speed. From a perspective described above, the carry speed of the negative electrode plate base material 20A is preferably equal to or less than 80 m/min, further preferably equal to or less than 75 m/min, furthermore preferably equal to or less than 70 m/min, or preferably in particular equal to or less than 65 m/min.

In addition, a laser processing speed at the tab cutting step S20 might be equal to or more than 26 m/min, might be equal to or more than 28 m/min, might be equal to or more than 30 m/min, or might be equal to or more than 32 m/min. The wording “laser processing speed” in the present specification means a mean value of relative movement speeds of a laser with respect to the electrode plate base material in carry. As described above, by moving the laser according to the carry direction of the electrode plate base material, the laser processing speed is decreased. In addition, by moving the laser in a direction opposite to the carry direction of the electrode plate base material, the laser processing speed is increased. It is possible to inhibit heat of the laser from being concentrated on a specific position if this laser processing speed becomes faster, and thus the cut quality variation can be suitably suppressed. Therefore, from a perspective of further suitably suppressing formation of the curved surface part, the laser processing speed is preferably equal to or more than 34 m/min, or preferably in particular equal to or more than 36 m/min.

Incidentally, at the tab cutting step S20, it is possible to use a conventionally known laser without particular restriction. In other words, the herein disclosed manufacturing method is not restricted by a kind of the laser. As one example of the laser capable of being used by the herein disclosed manufacturing method, it is possible to use a continuous wave laser (CW laser) or the pulse laser. Among them, the pulse laser can concentratedly add a large energy in a short time span (a peak output is high), and thus it is possible to promptly cut the electrode plate base material and to contribute in enhancing the manufacture efficiency. In a case where this pulse laser is applied, it is preferable to set several conditions of the laser irradiation as described below.

For example, a pulse width of the pulse laser is preferably equal to or more than 30 ns, further preferably equal to or more than 35 ns, furthermore preferably equal to or more than 40 ns, or preferably in particular equal to or more than 45 ns. By doing this, it is possible to inhibit a cut failure caused by an energy shortage. On the other hand, if the pulse width of the pulse laser is too long, an excessive energy is added to a periphery of the laser irradiation position, and thus a possibility of the curved surface part formed after the cut is increased. From a perspective described above, the pulse width of the pulse laser is preferably equal to or less than 120 ns, further preferably equal to or less than 110 ns, furthermore preferably equal to or less than 100 ns, or preferably in particular equal to or less than 90 ns.

In addition, a repetition frequency of the pulse laser is preferably equal to or less than 2250 kHz, further preferably equal to or less than 2200 kHz, furthermore preferably equal to or less than 2150 kHz, or preferably in particular equal to or less than 2100 kHz. By doing this, it is possible to suppress the curved surface part from being formed by the excess energy. On the other hand, the repetition frequency of the pulse laser is preferably equal to or more than 450 kHz, further preferably equal to or more than 500 kHz, furthermore preferably equal to or more than 550 kHz, or preferably in particular equal to or more than 600 kHz. By doing this, it is possible to inhibit the cut failure caused by the energy shortage.

In addition, a lap rate of the pulse laser is preferably equal to or less than 99%, further preferably equal to or less than 98.8%, furthermore preferably equal to or less than 98.4%, or preferably in particular equal to or less than 98.2%. An area size of the laser overlappingly irradiated on the same position of the electrode plate base material becomes smaller if the lap rate becomes smaller, and thus it becomes hard to have the curved surface part formed on the negative electrode tab 22t after the cut. The lap rate of the pulse laser is preferably equal to or more than 95%, further preferably equal to or more than 96%, furthermore preferably equal to or more than 97%, or preferably in particular equal to or more than 97.5%. By doing this, it is possible to suppress occurrence of the cut failure. Incidentally, the wording “lap rate” in the present specification is a value representing an overlapping extent of 2 spots positioned adjacent regarding the irradiation of the pulse laser. Incidentally, a spot diameter of the pulse laser is preferably 10 μm to 60 μm, further preferably 20 μm to 50 μm, or furthermore preferably 25 μm to 40 μm. By doing this, it is possible to easily cut out the negative electrode plate 20 from the negative electrode plate base material 20A.

### (Another Step)

As described above, the tab cutting step S20 in the present embodiment repeats the first step to the fourth step (dotted lines LN1 to LN4 in FIG. 3 and FIG. 4), so as to form the plural negative electrode tabs 22t. Then, in the manufacturing method in accordance with the present embodiment, as shown by the two-dot chain line C1 in FIG. 3, a central part in the shorter direction S of the negative electrode plate base material 20A is cut out along the longitudinal direction L. By doing this, it is possible to manufacture the negative electrode plate 20 in which the negative electrode tab 22t is formed only on one side of the edge part 20b1 of the electrode plate body 20b (see FIG. 2). Additionally, in the present embodiment, as shown by the two-dot chain line C2, the negative electrode plate base material 20A is cut along the shorter direction S at predetermined intervals in the longitudinal direction L. By doing this, it is possible to manufacture the negative electrode plate 20 having a desired length. Incidentally, at the cutting step performed on the negative electrode plate base material 20A along the two-dot chain lines C1, C2, a laser cut might not be used, and thus it is possible to use a cut blade, a metal mold, a cutter, or the like. Incidentally, in a case where the laser cut is used at the cutting step performed along the two-dot chain lines C1, C2, it is preferable, similarly to the above described tab cutting step S20, to use the laser. By doing this, it is possible to suitably suppressing the peel/fall-out of a fragment of the negative electrode active material layer 24. In addition, the cut along these two-dot chain lines C1, C2 might be suitably performed in accordance with a shape of the negative electrode plate after the manufacture, and is not to restrict the herein disclosed technique.

### Another Embodiment

Above, one embodiment of the herein disclosed technique has been explained. Incidentally, the above described embodiment is to show an example in which the herein disclosed technique is applied, and is not to restrict the herein disclosed technique.

For example, in the above described embodiment, the negative electrode plate is manufactured as the electrode plate. However, a manufacturing object regarding the herein disclosed manufacturing method of the electrode plate is not restricted to the negative electrode plate, and thus it might be the positive electrode plate. According to the herein disclosed manufacturing method, even in a case where the positive electrode plate is set to be the manufacturing object, it is possible to suppress the cut quality variation at the edge part of the electrode plate (the positive electrode plate) after the manufacture.

In addition, as shown in FIG. 1 and FIG. 3, the manufacturing method in accordance with the above described embodiment controls the irradiation position of the laser at the tab cutting step S20 to form the negative electrode tab 22t in which the second edge part 21b and the fourth edge part 21d are configured to extend in a direction approximately vertical to the longitudinal direction L (in other words, along the shorter direction S). However, the herein disclosed manufacturing method can form the negative electrode tab 22t in which the second edge part 21b and the fourth edge part 21d are inclined, as shown in FIG. 5. In particular, at the second step, by controlling the speed of the laser following in the first direction and controlling the movement angle θ1 of the laser, it is possible to adjust the inclined angle θ2 of the second edge part 21b after the manufacture. In particular, if the movement angle θ1 of FIG. 4 is made to be larger and the follow speed of the laser to the first direction is made to be slower, the inclined angle θ2 of the second edge part 21b of FIG. 5 tends to become larger (the inclination of the second edge part 21b becomes gentle). In addition, at the fourth step, similarly, it is possible by controlling the speed of the laser following in the first direction and controlling the movement angle θ3 of the laser to adjust the inclined angle θ4 of the fourth edge part 21d.

In addition, on the negative electrode plate 20 after the manufacture, the plural electrode tabs 22t are formed. Regarding these plural electrode tabs 22t, shapes might be different from each other. In that case, it is good that the first step to the fourth step are treated as 1 cycle and movement patterns of the absolute position of the laser are changed by every 1 cycle. For example, if the movement amounts along the shorter direction S at the second step and the fourth step are differentiated by every cycle, it is possible to form plural kinds of electrode tabs having different protrusion amounts of protruding from the first edge part 21a. In addition, if the movement angles θ1, θ3 at the second step and the fourth step and the follow speeds to the laser are differentiated by every cycle, it is possible to form plural kinds of electrode tabs in which the inclined angle θ2 of the second edge part 21b is different from the inclined angle θ4 of the fourth edge part 21d.

Although the present disclosure is explained above in detail, the above described explanation is merely an illustration. In other words, the herein disclosed technique contains ones in which the above described specific examples are deformed or changed.

### REFERENCE SIGNS LIST

20: Negative electrode plate
20A: Negative electrode plate base material
20b: Electrode plate body
20b1: Edge part
22: Negative electrode substrate
22t: Negative electrode tab
24: Negative electrode active material layer
A1: Negative electrode active material imparted area
A2: Negative electrode substrate exposed area

1. A manufacturing method of an electrode plate, comprising:
preparing a strip-like shaped electrode plate base material before a tab cut; and
manufacturing the electrode plate that comprises plural electrode tabs at an end part in a shorter direction, by carrying the electrode plate base material in a first direction being along a longitudinal direction of the electrode plate base material and irradiating a laser to the electrode plate base material in carry, wherein
at the manufacturing the electrode plate, a scanning speed of the laser on the electrode plate base material is controlled so as to make a relative speed of an irradiation position of the laser with respect to the electrode plate base material in carry be constant.

2. The manufacturing method of the electrode plate according to claim 1, wherein
the scanning speed of the laser is controlled to make the relative speed at an irradiation position be within a range of 90% to 110% when a mean value of the relative speed in a whole of the manufacturing the electrode plate is treated as 100%.

3. The manufacturing method of the electrode plate according to claim 1,
wherein the electrode plate after the manufacturing the electrode plate comprises:
a first edge part configured to extend in a longitudinal direction of the electrode plate;
a second edge part configured to extend to an outer side in the shorter direction from the first edge part;
a third edge part configured to extend in the longitudinal direction from a tip end of the second edge part; and
a fourth edge part configured to extend to an inner side in the shorter direction from the third edge part.

4. The manufacturing method of the electrode plate according to claim 3, wherein
the manufacturing the electrode plate comprises:
a first step of relatively moving the irradiation position of the laser toward a second direction that is a direction opposite to the first direction while the irradiation position of the laser is fixed in the shorter direction;
a second step of moving the irradiation position of the laser to an outer side of the shorter direction while moving the irradiation position of the laser in the first direction after the first step;
a third step of relatively moving the irradiation position of the laser toward a second direction while the irradiation position of the laser is fixed in the shorter direction after the second step; and
a fourth step of moving the irradiation position of the laser to an inner side of the shorter direction while moving the irradiation position of the laser in the first direction after the third step.

5. The manufacturing method of the electrode plate according to claim 4, wherein
a scanning speed A of the laser at the first step, a scanning speed B of the laser at the second step, a scanning speed C of the laser at the third step, and a scanning speed D of the laser at the fourth step satisfy formula (1) and formula (2) described below.
A=C<B (1)
A=C<D (2)

6. The manufacturing method of the electrode plate according to claim 5, wherein
the scanning speed A and the scanning speed C satisfy Formula (3) described below, the scanning speed B satisfies Formula (4) described below, and the scanning speed D satisfies Formula (5) described below, when a carry speed of the electrode plate base material is treated as V_{W}, a ratio of a total scanning distance of the laser with respect to a total length of the electrode plate base material is treated as α, an inclined angle of the second edge part with respect to the longitudinal direction of the electrode plate is treated as θ2, and an inclined angle of the fourth edge part with respect to the longitudinal direction of the electrode plate is treated as θ4.
A=C=V_{W}×α−V_{W} (3)
B=√(V_{W}²+V_{W}²×α−2V_{W}²×α×cos θ2) (4)
D=√(V_{W}²+V_{W}²×α−2V_{W}²×α×cos θ4) (5)

7. The manufacturing method of the electrode plate according to claim 4, wherein
a mean value of the relative speed is 120% to 130% when a carry speed of the electrode plate base material is treated as 100%.
